(19) United States
(12) Patent Application Publication
(10) Pub. No.: US 2016/0313156 A1
(43) Pub. Date: Oct. 27, 2016

(54) Waste Water Flow Quantifying Apparatus, Method and Computer Program

(71) Applicant: DYNAMIC FLOW TECHNOLOGIES LIMITED, Derby, Derbyshire (GB)

(72) Inventors: Martin James Croft, Coalville (GB); Duncan Kenneth Wallace, Nottingham (GB); Timothy Ian Morley, Loughborough (GB)

(21) Appl. No.: 15/103,536

(22) PCT Filed: Dec. 4, 2014
(86) PCT No.: PCT/GB2014/053601

§ 371 Date: Jun. 10, 2016

(30) Foreign Application Priority Data
Dec. 10, 2013 (GB) 1321788.0

(51) Int. Cl. G01F 1/66; G01S 13/88; G01S 13/38; G01F 23/284

(52) U.S. Cl. CPC G01F 1/66; G01F 23/284; G01S 13/88; G01S 13/38

(57) ABSTRACT

Waste water flow quantifying apparatus, a method and a computer program is provided. The waste water flow quantifying apparatus comprises microwave transceiver circuitry configured to transmit a first microwave signal into a closed conduit and configured to receive a first superposition microwave signal formed from a combination of the first microwave signal and a reflection, from within the closed conduit, of the first microwave signal. The microwave transceiver circuitry is configured to transmit a second microwave signal into the closed conduit. The second microwave signal has a different frequency from the first microwave signal or is out of phase with the first microwave signal. The microwave transceiver circuitry is configured to receive a second superposition microwave signal formed from a combination of the second microwave signal and a reflection, from within the closed conduit, of the second microwave signal. The microwave transceiver circuitry is configured to transmit a third microwave signal into the closed conduit. The third microwave signal has a different frequency from the first microwave signal or is out of phase with the first microwave signal. The third microwave signal has a different frequency from the second microwave signal or is out of phase with the second microwave signal. The microwave transceiver circuitry is configured to receive a third superposition microwave signal formed from a combination of the third microwave signal and a reflection, from within the closed conduit, of the third microwave signal. The waste water flow quantifying apparatus further comprises processing circuitry configured to quantify waste water flow through the closed conduit using a reading of the first superposition microwave signal, a reading of the second superposition microwave signal and a reading of the third superposition microwave signal provided by the microwave transceiver circuitry.

### CROSS-REFERENCE TO RELATED APPLICATIONS

This application is a filing under 35 U.S.C. 371 of International Application No. PCT/GB2014/053601 filed Dec. 4, 2014, entitled “Waster Water Flow Quantifying Apparatus, Method and Computer Program” claiming priority to GB Application No. 1321788.0 filed on Dec. 10, 2013, entitled “Waster Water Flow Quantifying Apparatus, Method and Computer Program”, which are incorporated by reference herein as if reproduced in their entirety.

### TECHNOLOGICAL FIELD

Embodiments of the present invention relate to quantifying waste water flow. In particular, they relate to using microwaves to quantify waste water flow in a closed conduit.

### BACKGROUND

Private and commercial properties include waste water drainage systems for draining waste water into public sewers. The water bill received by an owner or a tenant of a property may be estimated. The estimation may depend upon the amount of water that is used by the property and the surface area of land associated with the property, rather than an accurate assessment of the amount of water that is drained away from the property.

### BRIEF SUMMARY

According to various, but not necessarily all, embodiments of the invention there is provided waste water flow quantifying apparatus, comprising: microwave transceiver circuitry configured to transmit a first microwave signal into a closed conduit and configured to receive a first superposition microwave signal formed from a combination of the first microwave signal and a reflection, from within the closed conduit, of the first microwave signal; wherein the microwave transceiver circuitry is configured to transmit a second microwave signal, having a different frequency from the first microwave signal or being out of phase with the first microwave signal, into the closed conduit and configured to receive a second superposition microwave signal formed from a combination of the second microwave signal and a reflection, from within the closed conduit, of the second microwave signal; and wherein the microwave transceiver circuitry is configured to transmit a third microwave signal, having a different frequency from the first microwave signal or being out of phase with the first microwave signal and having a different frequency from the second microwave signal or being out of phase with the second microwave signal, into the closed conduit and configured to receive a third superposition microwave signal formed from a combination of the third microwave signal and a reflection, from within the closed conduit, of the third microwave signal; and the waste water flow quantifying apparatus further comprises: processing circuitry configured to quantify waste water flow through the closed conduit using a reading of the first superposition microwave signal, a reading of the second superposition microwave signal and a reading of the third superposition microwave signal provided by the microwave transceiver circuitry.

According to various, but not necessarily all, embodiments of the invention there is provided a method, comprising: transmitting a first microwave signal, from microwave transceiver circuitry, into a closed conduit; receiving a first superposition microwave signal formed from a combination of the first microwave signal and a reflection, from within the closed conduit, of the first microwave signal; transmitting a second microwave signal into the closed conduit from the microwave transceiver circuitry, the second microwave signal having a different frequency from the first microwave signal or being out of phase with the first microwave signal; receiving a second superposition microwave signal formed from a combination of the second microwave signal and a reflection, from within the closed conduit, of the second microwave signal; transmitting a third microwave signal into the closed conduit from microwave transceiver circuitry, the third microwave signal having a different frequency from the first microwave signal or being out of phase with the first microwave signal and the third microwave signal having a different frequency from the second microwave signal or being out of phase with the second microwave signal; receiving a third superposition microwave signal formed from a combination of the third microwave signal and a reflection, from within the closed conduit, of the third microwave signal; and quantifying waste water flow through the closed conduit using a reading of the first superposition microwave signal, a reading of the second superposition microwave signal and a reading of the third superposition microwave signal.

According to various, but not necessarily all, embodiments of the invention there is provided a non-transitory computer readable medium storing computer program instructions that, when performed by processing circuitry, cause at least the following to be performed: a method, comprising: transmitting a first microwave signal, from microwave transceiver circuitry, into a closed conduit; receiving a first superposition microwave signal formed from a combination of the first microwave signal and a reflection, from within the closed conduit, of the first microwave signal; transmitting a second microwave signal into the closed conduit from the microwave transceiver circuitry, the second microwave signal having a different frequency from the first microwave signal or being out of phase with the first microwave signal; receiving a second superposition microwave signal formed from a combination of the second microwave signal and a reflection, from within the closed conduit, of the second microwave signal; transmitting a third microwave signal into the closed conduit from microwave transceiver circuitry, the third microwave signal having a different frequency from the first microwave signal or being out of phase with the first microwave signal and the third microwave signal having a different frequency from the second microwave signal or being out of phase with the second microwave signal; receiving a third superposition microwave signal formed from a combination of the third microwave signal and a reflection, from within the closed conduit, of the third microwave signal; and quantifying waste water flow through the closed conduit using a reading of the first superposition microwave signal, a reading of the second superposition microwave signal and a reading of the third superposition microwave signal.

According to various, but not necessarily all, embodiments of the invention there is provided waste water flow quantifying apparatus, comprising: means for transmitting a first microwave signal, from microwave transceiver circuitry, into a closed conduit; means for receiving a first superposition microwave signal formed from a combination of the first microwave signal and a reflection, from within the closed conduit, of the first microwave signal; means for transmitting a second microwave signal into the closed conduit from the microwave transceiver circuitry, the second microwave signal having a different frequency from the first microwave signal or being out of phase with the first microwave signal; means for receiving a second superposition microwave signal formed from a combination of the second microwave signal and a reflection, from within the closed conduit, of the second microwave signal; means for transmitting a third microwave signal into the closed conduit from microwave transceiver circuitry, the third microwave signal having a different frequency from the first microwave signal or being out of phase with the first microwave signal and the third microwave signal having a different frequency from the second microwave signal or being out of phase with the second microwave signal; means for receiving a third superposition microwave signal formed from a combination of the third microwave signal and a reflection, from within the closed conduit, of the third microwave signal; and means for quantifying waste water flow through the closed conduit using a reading of the first superposition microwave signal, a reading of the second superposition microwave signal and a reading of the third superposition microwave signal.

### BRIEF DESCRIPTION

For a better understanding of various examples that are useful for understanding the detailed description, reference will now be made by way of example only to the accompanying drawings in which:

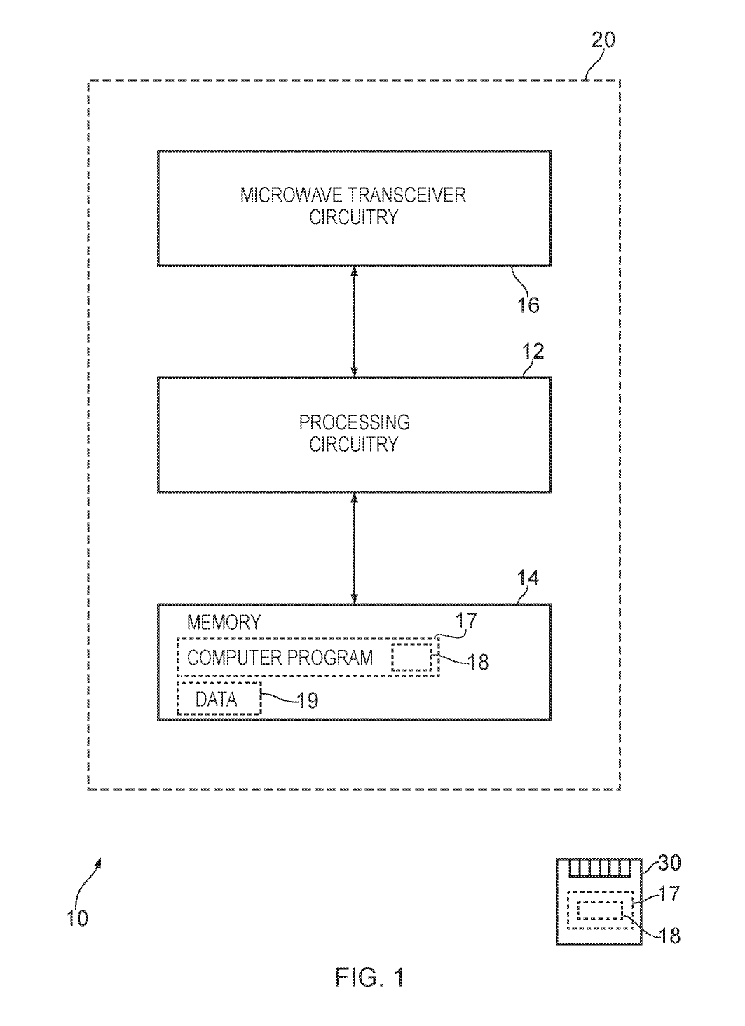

FIG. 1 illustrates a schematic of waste water flow quantifying apparatus;

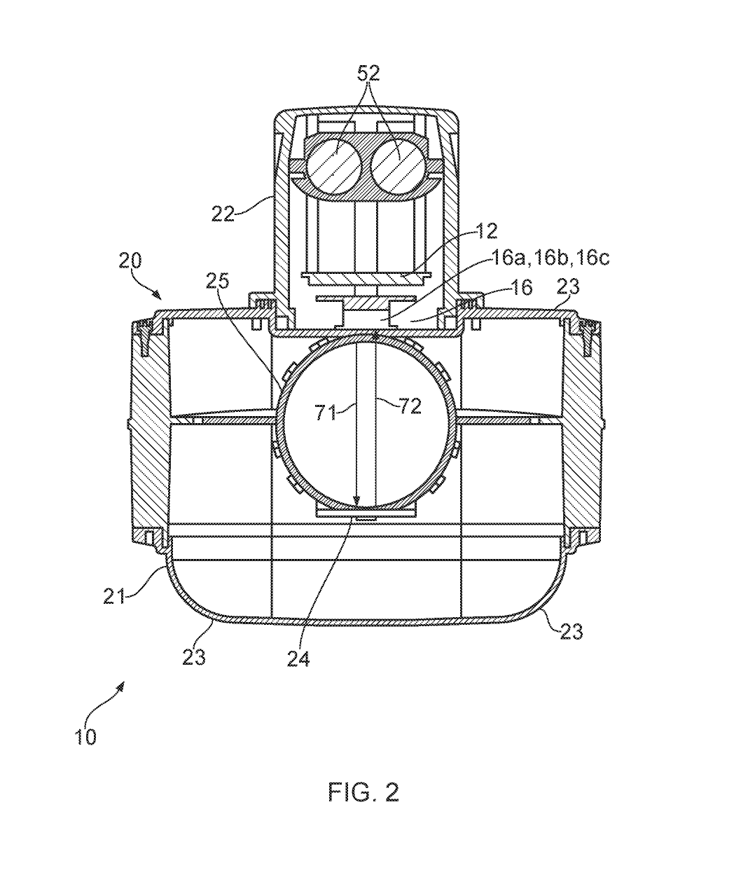

FIG. 2 illustrates a vertical cross section of the waste water flow quantifying apparatus;

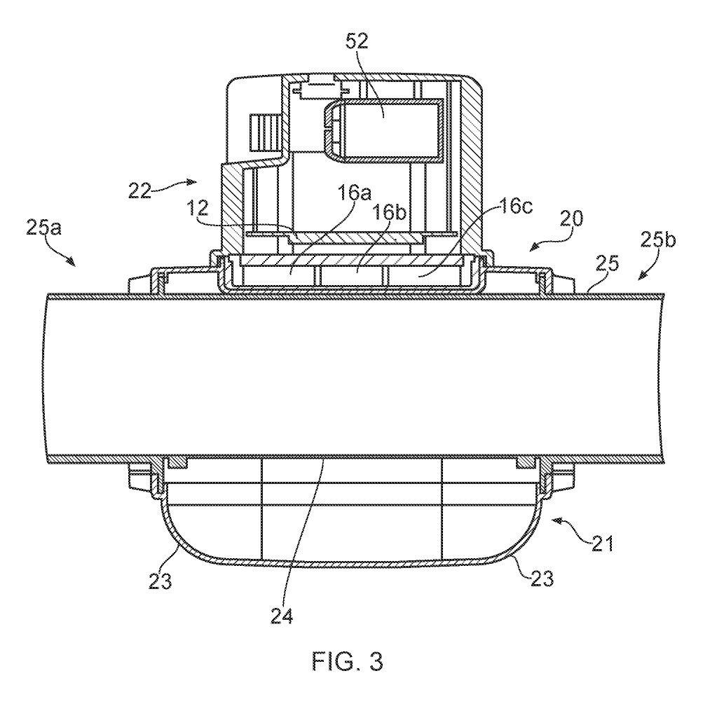

FIG. 3 illustrates a horizontal cross section of the waste water flow quantifying apparatus;

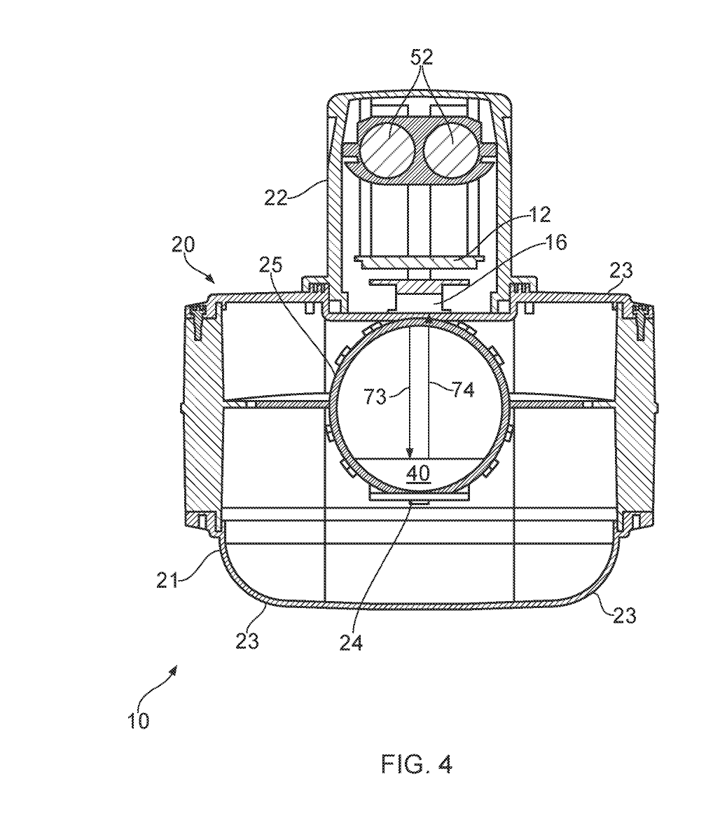

FIG. 4 illustrates a vertical cross section of the waste water flow quantifying apparatus showing waste water and the direction of the microwave travel;

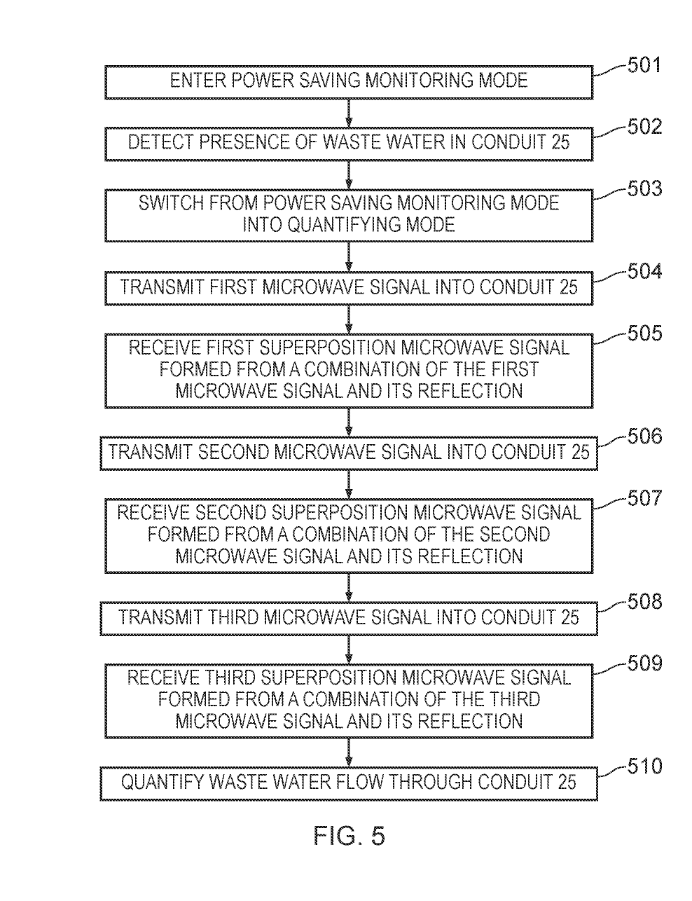

FIG. 5 illustrates a flow chart of a method; and

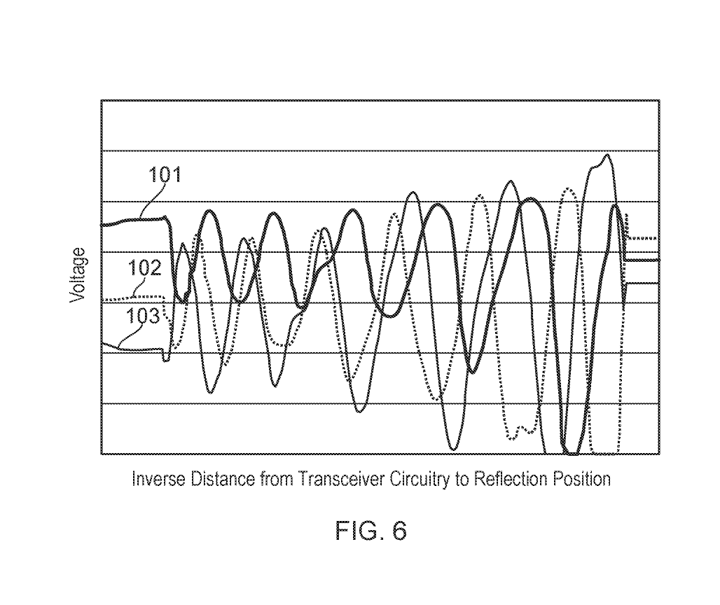

FIG. 6 illustrates a graph which shows voltage measured by microwave transceiver circuitry against inverse distance from the microwave transceiver circuitry to a position at which a microwave signal was reflected.

### DETAILED DESCRIPTION

Embodiments of the invention relate to quantifying waste water flow using non-invasive means.

FIG. 1 illustrates a schematic of waste water flow quantifying apparatus 10. The apparatus 10 comprises processing circuitry 12, a memory 14 and microwave transceiver circuitry 16.

The microwave transceiver circuitry 16 is configured to transmit and receive microwave signals of different forms. The microwave signals are transmitted and received in order to quantify waste water flow in a closed conduit.

In one particular example, the microwave transceiver circuitry 16 is configured to transmit first, second and third microwave signals. In some embodiments, a different microwave transceiver may be provided to transmit each of the first, second and third microwave signals. In other embodiments, a single microwave transceiver may be provided to transmit the first, second and third microwave signals. The first, second and third microwave frequencies signals may be time varying, sinusoidal signals. They may or may not be of different frequencies. If they are not of different frequencies, they are out of phase relative to one another.

The first, second and third microwave signals are transmitted by the microwave transceiver circuitry 16 when the apparatus 10 is in a ‘quantifying mode’. The first, second and third microwave signals may be transmitted cyclically in a time-sliced manner, such that only one of the first, second and third microwave signals is transmitted at any one time. Transmitting the microwave signals cyclically in a time-sliced manner advantageously enables power to be saved (for example, compared to if the first, second and third microwave signals were transmitted continuously and simultaneously).

The waste water flow quantifying apparatus 10 may also have a ‘power saving monitoring mode’ in which the microwave transceiver circuitry 10 is configured to transmit a microwave signal to monitor for the presence of waste water in a closed conduit. This is described in further detail later.

The processing circuitry 12 is configured to control the microwave transceiver circuitry 16 to transmit microwaves. It is also configured to receive and interpret readings made by the microwave transceiver circuitry 16. The processing circuitry 12 is further configured to quantify waste water flow through by using the readings made by the microwave transceiver circuitry 16.

The processing circuitry 12 is configured to read from and write to the memory 14. The processing circuitry 12 may use data 19 stored in the memory 14 in order to quantify waste water flow. The data 19 may take the form of a look up table. This is described in more detail below.

In some embodiments of the invention, the processing circuitry 12 may be dedicated, hardwired electronics. In this regard, it may, for example, comprise one or more application integrated specific circuits (ASICs). In other embodiments, the processing circuitry 12 may operate in accordance with a computer program 17 comprising computer program instructions 18. In such embodiments, the computer program instructions 18 provide the logic and routines that enable the apparatus 10 to perform the methods illustrated in FIG. 5. The processing circuitry 12, by reading the memory 14, is able to load and execute the computer program 17.

The computer program 17 may arrive at the apparatus 10 via any suitable delivery mechanism 30. The delivery mechanism 30 may be, for example, a non-transitory computer-readable storage medium such as a compact disc read-only memory (CD-ROM) or digital versatile disc (DVD). The delivery mechanism 30 may also be a signal configured to reliably transfer the computer program 17.

FIG. 1 illustrates the memory 14 storing data 19 and a computer program 17. Although the memory 14 is illustrated as a single component it may be implemented as one or more separate components some or all of which may be integrated/removable and/or may provide permanent/semi-permanent/dynamic/cached storage.

In some examples, the apparatus 10 may comprise one or more orientation sensors that are configured to sense the orientation of the apparatus 10. The orientation sensors may be configured to sense the orientation of the apparatus 10 in one, two or three dimensions. The processing circuitry 12 may be configured to quantify waste water flow through a conduit in dependence upon inputs provided by the orientation sensor(s).

The apparatus 10 may also comprise a display in some embodiments. In these embodiments, the processing circuitry 12 may control the display to display a quantity of waste water that is flowing or has flowed through a closed conduit.

The elements 12, 14, 16 illustrated in FIG. 1 are operationally coupled and any number or combination of intervening elements can exist between them (including no intervening elements).

FIG. 2 illustrates a vertical cross section of the waste water flow quantifying apparatus 10 and FIG. 3 illustrates a horizontal cross section of the waste water flow quantifying apparatus 10. The waste water flow quantifying apparatus 10 further comprises a housing 20. The housing 20 comprises a fixed portion 21 and a user detachable portion 22. The fixed portion 21 may be located above ground, underground or partially underground. The user detachable portion 22 is typically located above ground.

The fixed portion 21 of the housing 20 is defined by an outer wall 23 and comprises a closed conduit 25 which, in the illustrated example, is a pipe. The closed conduit 25 has a continuous circumferential wall. The closed conduit 25 is considered to be ‘closed’ because it does not include an opening in its circumferential wall.

In this example, the conduit 25 has a circular cross section. In other examples, the cross section of the conduit 25 may be non-circular.

One end 25a of the conduit is configured to be attached to an end of a first external conduit, such as a first waste water pipe. Another end 25b of the conduit 25 is configured to be attached to an end of a second external conduit, such as a second waste water pipe. When the conduit 25 is attached to first and second external conduits, waste water may flow from the first external conduit, through the conduit 25 of the apparatus 10 and into the second external conduit (without any waste water being lost). The conduit 25 of the apparatus 10 may be of substantially the same diameter as the external conduits it is connected to.

The apparatus 10 may, for example, be fitted retrospectively to a waste water conduit of an existing building by cutting out a small portion of the waste water conduit. Alternatively, the apparatus 10 could be fitted proactively when a new building is built.

In the illustrated example, one or more batteries 52, the processing circuitry 12 and the microwave transceiver circuitry 16 are located in the user detachable portion 22 of the housing 20. The batteries 52 are for powering the processing circuitry 12 and the microwave transceiver circuitry 16. In other examples, the processing circuitry 12 and/or the microwave transceiver circuitry 16 might not be located in the user detachable portion 22 of the housing 25. The user detachable nature of the user detachable portion 22 enables the batteries 52 to be replaced easily.

A reflector 24 is positioned inside the fixed portion 21 of the housing 20 and outside the closed conduit 25. The reflector 24 is arranged to reflect microwave signals transmitted by the microwave transceiver circuitry 16 in the opposite direction from the direction that they were transmitted in. The microwave transceiver circuitry 16 (which, in the illustrated example, comprises first, second and third microwave transceivers 16a, 16b, 16c) is configured to transmit microwaves through the conduit 25 and towards the reflector 24.

In the example illustrated in FIG. 2, there is no waste water in the conduit 25. Microwave signals transmitted by the microwave transceiver circuitry 16 travel in the direction illustrated by the arrow labelled with the reference numeral 71. The microwave signals travel through the circumferential wall of the conduit 25 and into the conduit 25, before exiting the conduit 25 via the circumferential wall and reaching the reflector 24. The reflector 24 then reflects the transmitted microwave signals, directing them back through the circumferential wall and into the conduit 25 as shown by the arrow labelled with the reference numeral 72 in FIG. 2. The microwave signals then exit the conduit 25 via the circumferential wall and reach the microwave transceiver circuitry 16, where they are received.

FIG. 4 illustrates an example in which waste water 40 is flowing through the conduit 25. In FIG. 4, the microwave signals transmitted into the conduit 25 by the microwave transceiver circuitry 12 are reflected by the surface of the waste water 40 before they reach the reflector 24. This is because a strong contrast in the permittivity in the medium(s) in which a microwave signal is travelling causes the signal to be reflected.

In embodiments of the invention, superposition microwave signals formed from combinations of transmitted microwave signals and their reflections off the surface of waste water 40 travelling in the conduit 25 enable the distance between the microwave transceiver circuitry 16 and the surface of the waste water 40 to be determined. This is described in further detail later.

Once the distance between the microwave transceiver circuitry 16 and the surface of the waste water 40 is known, since the dimensions of the conduit 25 are known, the height of the waste water 40 in the conduit 25 can also be determined. The determined value for the height of the waste water 40 may be used to quantify waste water flow through the conduit 25.

Quantifying the waste water flow through the conduit 25 may involve determining the amount of waste water that is present in the conduit 25 at a particular instance in time, and/or determining the amount of waste water 40 that has flowed (or is flowing) through the conduit 25 over a period of time.

In more detail, once the height of the waste water 40 is known, since the dimensions of the conduit 25 are also known, the hydraulic radius Rh can be calculated using the following equation:

$${R}_{h} = \frac{A}{P}$$

where: A=the cross sectional area of flow of the waste water 40 and P=the wetted perimeter of the conduit 25.

The cross sectional area of flow A indicates the amount of waste water 40 flowing through the conduit 25 at a particular time.

The average cross-sectional velocity or flow of the waste water 40 in the conduit 25 can be calculated using the Manning equation (also known as the Gauckler- Manning equation and the Gauckler-Manning-Strickler equation):

$$V = \frac{k}{n} {R}_{h}^{2 \text{/} 3} {S}^{1 \text{/} 2}$$

where: V=average cross-sectional velocity of the waste water 40, k=a conversion constant equal to 1 for SI units, n is the Gauckler-Manning co-efficient, Rₕ is the hydraulic radius and S is the slope of the waste water surface.

The Gauckler-Manning co-efficient depends upon the material that the conduit 25 is made from. If the apparatus 10 comprises one or more orientation sensors, inputs from these sensors may be used to determine the slope S of the waste water surface.

When the average cross sectional velocity V has been calculated, it can be used to determine the amount of waste water (for example, the volume of waste water) that has flowed through the conduit 25 over a period of time.

An outer wall 23 of the fixed part 21 of the housing 20 is shaped such that the fixed part 21 of housing 20 encompasses a substantial volume outside the circumferential wall of the closed conduit 25. In the example illustrated in FIGS. 2 and 3, much of this volume is taken up by air, but in other examples it may be taken up by another substance that is substantially transparent to microwaves, such as a plastics material.

The housing 20 is watertight. The volume occupied by the fixed part 21 of the housing 20 prevents water (such as moisture in wet ground) from being positioned outside of, but close to, the closed conduit 25. This advantageously helps to reduce error in waste water flow calculations made using the apparatus 10, because water positioned outside of, but close to, the closed conduit 25 may reflect microwaves, which could potentially cause errors in the determination of the height of the waste water 40 flowing in the conduit 25.

An example of a method according to embodiments of the invention will now be described in relation to FIGS. 5 and 6 in particular. In this example, the microwave transceiver circuitry 16 comprises first, second and third microwave transceivers 16a, 16, 16c as illustrated in FIG. 3. Each microwave transceiver 16a, 16b, 16c is configured to transmit a time-varying, sinusoidal microwave signal of a different frequency.

The first microwave signal is transmitted by the first microwave transceiver 16a and has a first frequency. The second microwave signal is transmitted by the second microwave transceiver 16b and has a second frequency. The third microwave signal is transmitted by the third microwave transceiver 16c has a third frequency. However, in other examples, the transmitted first, second and third microwave signals may instead be of the same frequency and may be phase offset relative to one another. That is, there may be a difference in phase between the transmitted first microwave signal and both the second and third microwave signals, and a difference in phase between the second microwave signal and the third microwave signal.

At block 501, the apparatus 10 enters its power saving monitoring mode. This may occur, for example, when it is switched on initially. The apparatus 10 consumes less power when it is in the power saving monitoring mode than when it is in quantifying mode. This may be because, for example, the time interval between consecutive microwave signals being transmitted is smaller in the quantifying mode than in the power saving monitoring mode.

When the apparatus 10 is in the power saving monitoring mode, the processing circuitry 12 causes the first microwave transceiver 16a to transmit a first, time varying, sinusoidal, microwave signal into the closed conduit 25 periodically, to monitor for the presence of waste water in the conduit 25. The second and third microwave signals are not transmitted while the apparatus 10 is in the power saving monitoring mode and the second and third microwave transceivers 16b, 16c are not operational.

The first microwave signal is transmitted in the direction of the arrow labelled with the reference numeral 71 in FIG. 2. The first microwave signal is reflected by the reflector 24 in the direction of the arrow labelled with the reference numeral 72 in FIG. 2.

The transmission of the first microwave signal and its reflection interfere with one another. Since the first microwave signal is a time varying, sinusoidal signal, its electric field varies over time. This also means that the electric field of the reflection of the first microwave signal varies over time in a corresponding fashion.

The first microwave signal and the reflection of the first microwave signal combine/interfere to produce a first superposition microwave signal, which is received by the first microwave transceiver 16a. The first superposition microwave signal is a signal that represents the difference in phase between the transmitted first microwave signal and its reflection. A reading of the first superposition microwave signal made by the first microwave transceiver 16a therefore indicates and depends upon a phase relationship between the transmitted first microwave signal and its reflection, at the position where the reading is taken. The first microwave transceiver 16a provides a reading of the first superposition microwave signal to the processing circuitry 12.

When there is no waste water 40 in the conduit 25 and the first microwave signal is being reflected by the reflector 24, the reading of the first superposition microwave signal is a constant value. That is, the value of the reading is constant, over a period of time, while the first superposition microwave signal is being received.

When the processing circuitry 12 receives input readings from the first microwave transceiver 16a of a constant value, it interprets the reading as an indication that there is no waste water 40 in the conduit 25.

The apparatus 10 remains in the power saving monitoring mode until waste water 40 is detected in the closed conduit 25. At block 501 in FIG. 5, waste water 40 appears the conduit 25, as illustrated in FIG. 4. When the waste water 40 appears, the first microwave signal is reflected by the surface of the waste water 40 rather than the reflector 24. The level of the waste water 40 increases gradually, over time, which causes the reading provided by the first microwave transceiver 16a to change gradually over time.

A changing reading from the first microwave transceiver 16a indicates the presence of waste water 40 in the conduit 25 to the processing circuitry 12. If the reading provided by the first microwave transceiver 16a changes by more than a predefined threshold, the processing circuitry 12 responds by causing the apparatus 10 enter the quantifying mode. At block 502 in FIG. 5, the processing circuitry 12 detects the presence of waste water 40 in the conduit 25 and switches the apparatus 10 from the power saving monitoring mode into the quantifying mode.

In the quantifying mode, the processing circuitry 12 causes the microwave transceiver circuitry 16 to transmit the first, second and third microwave signals cyclically in a time-sliced manner, such that only one of the first, second and third microwave signals is transmitted at any one time. In this example, one of the microwave signals that is transmitted (the first microwave signal) is the same signal that is transmitted when the apparatus 10 is in the power saving monitoring mode, but that need not necessarily be the case.

In this example, when the apparatus 10 enters the quantifying mode, the processing circuitry 12 causes the first, second and third microwave signals to be transmitted cyclically in a time-sliced manner by rapidly switching each transceiver 16a, 16b, 16c on and off in turn, such that only one transceiver is operational and transmitting at any one instance in time. This is described below.

At block 504 in FIG. 5, the processing circuitry 12 activates the first microwave transceiver 16a, causing it to transmit the first microwave signal into the closed conduit, in the direction as illustrated by the arrow 73 in FIG. 4.

The first microwave signal reflects off the surface of the waste water 40 and is directed back towards the first microwave transceiver 16a, as illustrated in FIG. 4.

At block 505 in FIG. 5, the first microwave transceiver 16b receives a first superposition microwave signal formed from a combination (i.e. the interference) of the first microwave signal and the reflection, from within the closed conduit 25, of the first microwave signal off the waste water 40.

The first microwave transceiver 16b takes a reading of the first superposition microwave signal and provides it to the processing circuitry 12.

At block 506 in FIG. 5, the processing circuitry 12 deactivates the first microwave transceiver 16a, causing it to cease transmitting the first microwave signal. The processing circuitry 12 also activates the second microwave transceiver 16b, causing it to transmit the second microwave signal into the closed conduit, in the direction as illustrated by the arrow 73 in FIG. 4.

At block 507, the second microwave transceiver 16b receives a second superposition microwave signal formed from a combination (i.e. the interference) of the second microwave signal and the reflection, from within the closed conduit 25, of the second microwave signal off the waste water 40.

The second microwave transceiver 16b takes a reading of the second superposition microwave signal and provides it to the processing circuitry 12.

At block 508, the processing circuitry 12 deactivates the second microwave transceiver 16b, causing it to cease transmitting the second microwave signal. The processing circuitry 12 also activates the third microwave transceiver 16c, causing it to transmit the third microwave signal into the closed conduit, in the direction as illustrated by the arrow 73 in FIG. 4.

At block 509, the third microwave transceiver 16c receives a third superposition microwave signal formed from a combination (i.e. the interference) of the third microwave signal and the reflection, from within the closed conduit 25, of the third microwave signal off the waste water 40.

The third microwave transceiver 16c takes a reading of the third superposition microwave signal and provides it to the processing circuitry 12.

At block 510 in FIG. 5, the processing circuitry 12 quantifies waste water flow through the closed conduit 25 using the readings of the first, second and third superposition microwave signals from made by the first, second and third microwave transceivers 16a, 16b, 16c.

FIG. 6 illustrates a graph in which the y-axis represents a voltage value measured by the microwave transceivers 16a, 16b, 16c and the x-axis represents the inverse distance from the microwave transceivers 16a, 16b, 16c to the position at which a microwave signal was reflected. The x-axis represents an “inverse distance” in the sense that the left hand side of the x-axis relates to positions close to the reflector 24, whereas the right hand side of the x-axis relates to positions close to the microwave transceivers 16a, 16b, 16c.

A first line 101 on the graph is indicative of the reading that would be provided by the first microwave transceiver 16a when the first superposition microwave signal is read. The first superposition microwave signal represents the difference in phase between the transmitted first microwave signal and its reflection. A reading of the first superposition microwave signal made by the first microwave transceiver 16a therefore indicates and depends upon a phase relationship between the transmitted first microwave signal and its reflection, at the position where the reading is taken. This phase relationship, and therefore the reading, depends upon the height of the waste water 40 in the conduit 25.

A second line 102 on the graph is indicative of the reading that would be provided by the second microwave transceiver 16b when the second superposition microwave signal is read. The second superposition microwave signal represents the difference in phase between the transmitted second microwave signal and its reflection. A reading of the second superposition microwave signal made by the second microwave transceiver 16b therefore indicates and depends upon a phase relationship between the transmitted second microwave signal and its reflection, at the position where the reading is taken. This phase relationship, and therefore the reading, depends upon the height of the waste water 40 in the conduit 25.

A third line 103 on the graph is indicative of the reading that would be provided by the third microwave transceiver 16c when the third superposition microwave signal is read. The third superposition microwave signal represents the difference in phase between the transmitted third microwave signal and its reflection. A reading of the third superposition microwave signal made by the third microwave transceiver 16c therefore indicates and depends upon a phase relationship between the transmitted third microwave signal and its reflection, at the position where the reading is taken. This phase relationship, and therefore the reading, depends upon the height of the waste water 40 in the conduit 25.

The fluctuation in the voltage values is greater on the right hand side of the graph than on the left hand side. This is because a reflection of a microwave signal has a greater amplitude when the microwave signal is reflected closer to the microwave transceivers 16a, 16b, 16c.

The memory 14 stores data 19 in the form of a look up table. The look up table associates distances, as measured from the microwave transceivers 16a, 16b, 16c towards the reflector 24, with values for the first, second and third superposition microwave signal readings. Effectively, the look up table includes the information displayed in graphical form in FIG. 6. For each particular distance value d in the table, there is an associated value for the first superposition microwave signal reading, an associated value for the second superposition microwave signal reading and an associated value for the third superposition microwave signal reading.

The processing circuitry 12 determines the distance d from the microwave transceivers 16a, 16b, 16c to the surface of the waste water 40 by comparing the readings from the microwave transceivers 16a, 16b, 16c with the sets of stored readings in the look up table. This enables the processing circuitry 12 to determine a unique value for the distance d and, in turn, a unique value for the height of the waste water 40.

If only two microwave signals were used by the apparatus 10 to determine the distance d rather than three, there might be some instances where the readings taken of the first and second superposition microwave signals correspond with two possible distance values d, rather than a single unique value, making it difficult to determine which distance value is the correct value. However, since three microwave signals are used, no such issue exists.

When the height of the waste water 40 is known, the flow of waste water 40 through the conduit 25 can be quantified using the method of calculation described above.

Once the processing circuitry 12 has quantified the waste water flow, it causes the apparatus 10 to switch from the quantifying mode back into the power saving monitoring mode.

Embodiments of the invention advantageously provide a reliable, non-invasive method and apparatus for quantifying waste water flow in a conduit. The microwave transceiver circuitry 16 comprises no moving parts and is able to operate in adverse environmental conditions such as in the presence of dust or water vapour, and/or when the temperature is high or low. The apparatus does not interfere with the flow of the waste water and can be used to accurately quantify the flow from a particular property. This may advantageously enable water companies to levy more accurate charges to customers.

References to ‘computer-readable storage medium’, or ‘processing circuitry’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analogue and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

The blocks illustrated in FIG. 5 may represent steps in a method and/or sections of code in the computer program 17. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, the microwave transceiver circuitry 16 could provide current readings to the processing circuitry 12 instead of voltage readings when microwave signals are detected.

In FIGS. 2, 3 and 4, the microwave transceivers 16a, 16b and 16c are positioned such that their emitting surface is substantially parallel to the surface of static/slowly moving waste water 40 in the conduit 25 when such waste water 40 flows in the conduit 25. In other examples of the invention, the microwave transceivers 16a, 16b, 16c may be positioned such that their emitting surface is angled relative to the surface of such waste water 40, and such that microwave signals are transmitted diagonally towards the waste water 40. In these examples, the reflector 24 may be repositioned (relative to example illustrated in FIGS. 2, 3, 4), to cause the microwave signals to be reflected in the opposite direction from the direction that they were transmitted in. Readings provided by the microwave transceivers 16a, 16b, 16c when they are positioned in this manner may give a better indication of the profile of the surface of waste water 40 flowing in the conduit 25, (for example, a better indication of the ‘rippling’ on the surface of the waste water 40), enabling the type of flow (for example, laminar flow, turbulent flow, etc.) to be determined more easily and therefore enable waste water flow to be quantified more accurately.

In some implementations, the apparatus 10 may comprise a transmitter/transceiver that is controlled by the processing circuitry 12 and enables waste water quantity measurements to be transmitted to a remote location (for example, on demand, if a request for a measurement is received). The transceiver could, for example, be a wireless transmitter/transceiver such as a Wi-Fi transceiver.

It was explained above that when the apparatus 10 is in its power saving monitoring mode and there is no waste water 40 in the conduit 25, the reading of the first superposition microwave signal is a constant value. Given that the distance between the microwave transceiver circuitry 16 and the reflector 24 is fixed, the reading of the first superposition microwave signal will always be the same constant value when there is no waste water 40 in the conduit.

If, for example, the conduit 25 were blocked and stagnant waste water 40 were present in the conduit 25, the reading of the first superposition microwave signal would also be a constant value. This value may or may not be different from the value provided when there is no waste water 40 in the conduit 25 (depending upon the height of the stagnant waste water 40 in the conduit 25 and how the first microwave signal and its reflection interfere).

In some embodiments of the invention, when the apparatus 10 is in its power saving monitoring mode and the processing circuitry 12 receives input readings from the first microwave transceiver 16a, over time, that are of any constant value, it interprets the readings as an indication that there is no waste water 40 in the conduit 25.

In other embodiments of the invention, when the apparatus 10 is in its power saving monitoring mode and the processing circuitry 12 receives input readings from the first microwave transceiver 16a that are of a particular constant value (or, at least, approximately that particular constant value), it interprets those readings as an indication that there is no waste water 40 in the conduit 25. In these embodiments, readings of a constant value that are different from the particular constant value are interpreted as an indication that something other than the reflector 24 is reflecting the first microwave signal from within the closed conduit 25 (such as stagnant waste water 40). If the processing circuitry 12 determines that this is occurring, it may cause an alert to be provided to a user (for example, by controlling the display to display an alert).

In some embodiments, the processing circuitry 12, the microwave transceiver 16 and the one or more batteries 52 may be placed in one or more water tight enclosures to protect them from water damage. The water tight enclosure(s) may be situated within the housing 20. Alternatively or additionally, the user detachable portion 22 that may house the processing circuitry 12, the microwave transceiver 16 and/or the one or more batteries 52 might be watertight.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/we claim:

1. Waste water flow quantifying apparatus, comprising:
microwave transceiver circuitry configured to transmit a first microwave signal into a closed conduit and configured to receive a first superposition microwave signal formed from a combination of the first microwave signal and a reflection, from within the closed conduit, of the first microwave signal;
wherein the microwave transceiver circuitry is configured to transmit a second microwave signal, having a different frequency from the first microwave signal or being out of phase with the first microwave signal, into the closed conduit and configured to receive a second superposition microwave signal formed from a combination of the second microwave signal and a reflection, from within the closed conduit, of the second microwave signal; and
wherein the microwave transceiver circuitry is configured to transmit a third microwave signal, having a different frequency from the first microwave signal or being out of phase with the first microwave signal and having a different frequency from the second microwave signal or being out of phase with the second microwave signal, into the closed conduit and configured to receive a third superposition microwave signal formed from a combination of the third microwave signal and a reflection, from within the closed conduit, of the third microwave signal; and the waste water flow quantifying apparatus further comprises:
processing circuitry configured to quantify waste water flow through the closed conduit using a reading of the first superposition microwave signal, a reading of the second superposition microwave signal and a reading of the third superposition microwave signal provided by the microwave transceiver circuitry.

2. The waste water flow quantifying apparatus as claimed in claim 1, wherein the microwave transceiver circuitry comprises: a first microwave transceiver configured to transmit the first microwave signal and receive the first superposition microwave signal; a second microwave transceiver configured to transmit the second microwave signal and receive the second superposition microwave signal; and a third microwave transceiver configured to transmit the third microwave signal and receive the third superposition microwave signal.

3. The waste water flow quantifying apparatus as claimed in claim 1, wherein the first microwave signal has a first frequency, the second microwave signal has a second frequency different from the first frequency, and the third microwave signal has a third frequency different from the first frequency and the second frequency.

4. The waste water flow quantifying apparatus as claimed in claim 1, wherein the processing circuitry is configured to quantify waste water flow through the closed conduit by comparing the readings of the first, second and third superposition microwave signals with data stored in a memory.

5. The waste water flow quantifying apparatus as claimed in claim 4, wherein the readings of the first, second and third superposition microwave signals depend upon a height of waste water in the closed conduit.

6. The waste water flow quantifying apparatus as claimed in claim 4, wherein the reading of the first superposition microwave signal depends upon a phase relationship between the first microwave signal and the reflection of the first microwave signal, the reading of the second superposition microwave signal depends upon a phase relationship between the second microwave signal and the reflection of the second microwave signal, and the reading of the third superposition microwave signal depends upon a phase relationship between the third microwave signal and the reflection of the third microwave signal.

7. The waste water flow quantifying apparatus as claimed in claim 4, wherein the processing circuitry determines a height of waste water in the closed conduit by comparing the readings of the first, second and third superposition microwave signals with data stored in a memory.

8. The waste water flow quantifying apparatus as claimed in claim 7, wherein comparing the readings of the first, second and third superposition microwave signals with data stored in a memory enables the processing circuitry to determine a unique value for the height of the waste water in the closed conduit.

9. The waste water flow quantifying apparatus as claimed in claim 1, wherein the waste water flow quantifying apparatus has a power saving monitoring mode in which the first microwave signal is transmitted to monitor for the presence of waste water in the closed conduit, and in which the second and third microwave signals are not transmitted, and wherein the processing circuitry is configured, in response to the microwave transceiver circuitry providing a reading that is indicative of waste water having entered the closed conduit, to switch the waste water flow quantifying apparatus from the power saving monitoring mode into a quantifying mode in which the first, second and third microwave signals are transmitted.

10. (canceled)

11. The waste water flow quantifying apparatus as claimed in claim 1, wherein the processing circuitry is configured to cause the microwave transceiver circuitry to transmit the first, second and third microwave signals cyclically in a time-sliced manner, such that only one of the first, second and third microwave signals is transmitted at any one time.

12. The waste water flow quantifying apparatus as claimed in claim 1, further comprising a housing.

13. The waste water flow quantifying apparatus as claimed in claim 12, wherein the housing is arranged to prevent reflections of the first, second and third microwave signals from occurring within a volume around the closed conduit by occupying the volume.

14. The waste water flow quantifying apparatus as claimed in claim 12, wherein the housing comprises the closed conduit into which the first, second and third microwave signals are transmitted.

15. The waste water flow quantifying apparatus as claimed in claim 14, wherein the closed conduit of the housing is configured to be attached to an end of a first conduit and an end of a second conduit, in order to enable waste water to flow from the first conduit, through the apparatus and into the second conduit.

16. The waste water flow quantifying apparatus as claimed in claim 12, wherein the processing circuitry is located in a user detachable portion of the housing.

17. The waste water flow quantifying apparatus as claimed in claim 16, wherein the microwave transceiver circuitry is located in the user detachable portion of the housing.

18. The waste water flow quantifying apparatus as claimed in claim 16, wherein the microwave transceiver circuitry and the processing circuitry are powered by one or more batteries, and the one or more batteries are located in the user detachable portion of the housing.

19. The waste water flow quantifying apparatus as claimed in claim 1, further comprising one or more orientation sensors configured to sense the orientation of the apparatus, wherein the processing circuitry configured to quantify waste water flow through the closed conduit in dependence upon one or more inputs from the one or more orientation sensors.

20. A method, comprising:
transmitting a first microwave signal, from microwave transceiver circuitry, into a closed conduit;
receiving a first superposition microwave signal formed from a combination of the first microwave signal and a reflection, from within the closed conduit, of the first microwave signal;
transmitting a second microwave signal into the closed conduit from the microwave transceiver circuitry, the second microwave signal having a different frequency from the first microwave signal or being out of phase with the first microwave signal;
receiving a second superposition microwave signal formed from a combination of the second microwave signal and a reflection, from within the closed conduit, of the second microwave signal;
transmitting a third microwave signal into the closed conduit from microwave transceiver circuitry, the third microwave signal having a different frequency from the first microwave signal or being out of phase with the first microwave signal and the third microwave signal having a different frequency from the second microwave signal or being out of phase with the second microwave signal;
receiving a third superposition microwave signal formed from a combination of the third microwave signal and a reflection, from within the closed conduit, of the third microwave signal; and
quantifying waste water flow through the closed conduit using a reading of the first superposition microwave signal, a reading of the second superposition microwave signal and a reading of the third superposition microwave signal.

21. A non-transitory computer readable medium storing a computer program comprising computer program instructions that, when executed by processing circuitry, cause the method as claimed in claim 20 to be performed.

22. (canceled)

23. (canceled)
